(19) United States
(12) Patent Application Publication
(10) Pub. No.: US 2008/0199716 A1
(43) Pub. Date: Aug. 21, 2008

(54) Multiple Component Electrical Contact

(75) Inventors: Romano Elidi, Treviolo (IT); Massimo Maura, Ceccano (IT)

Correspondence Address: Connolly Bove Lodge & Hutz LLP, 1875 Eye Street, NW, Suite 1100, Washington, DC, 20006, US

(73) Assignee: ABB SERVICE S.R.L., Milano (IT)

(21) Appl. No.: 11/914,128

(22) PCT Filed: May 3, 2006
(86) PCT No.: PCT/EP2006/062003

§ 371 Date: Nov. 9, 2007

(30) Foreign Application Priority Data
May 11, 2005 (IT) BG2005A000020

(51) Int. Cl. B32B 15/01; B22F 7/02

(52) U.S. Cl. 428/548; 419/6; 428/615; 428/673

(57) ABSTRACT

Electrical contact device, in particular for low-voltage switches and contactors, comprising a contact element produced in one piece. Said contact element comprises in particular a first conducting area and a second contact area, said first area and said second area being produced with materials of different types. The device according to the invention is suitably produced through a sintering process of at least two powders of conductive material of different types, in order to define in said contact element a first conducting area produced with a first of said powders, and a second contact area produced with a second of said powders.

The present invention relates to an electrical contact, in particular for switches and contactors, produced starting with powders, and to a method for the production thereof.

As is known, switches and contactors, in particular low-voltage switches and contactors, include main contacts of the fixed type and of the mobile type. The fixed and mobile contacts normally comprise at least one area for conducting current and one area for actually closing and opening the electrical contact. As these two different areas must perform different functions they are normally made of different materials; in particular, the areas for conducting current are normally made of copper (Cu) or are copper based, while the areas for closing and opening of the electrical contact are normally made of materials which, besides having good electrical conductivity properties, are particularly resistant to mechanical stresses and to the high temperatures typical of the electric arc, and are normally produced with technologies typical of powder metallurgy, for example by sintering silver based powders (i.e. Ag/Ni, Ag/C, Ag/WC, Ag/W or the like). The two areas of the contacts described above are commonly respectively called electrodes (fixed or mobile) and contact plates, the electrodes being principally for conducting and the contact plates for closing and opening the contact.

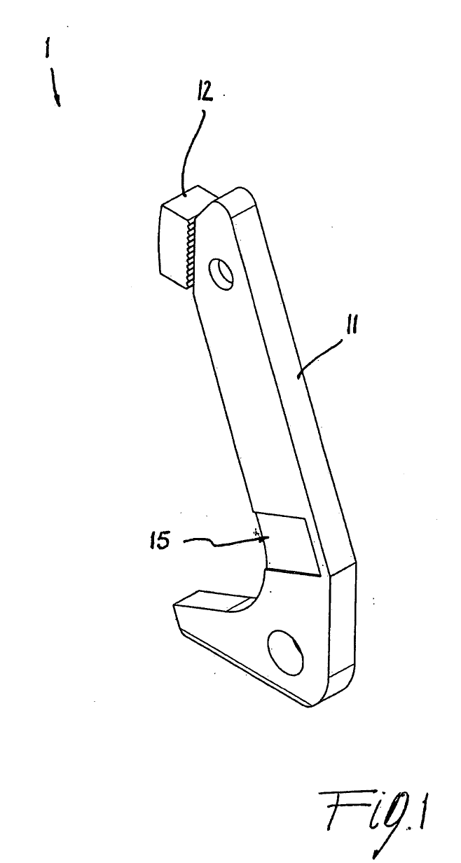

An example of a contact element of known type is represented in the accompanying FIG. 1, in which it can be seen that the contact element 1 comprises an electrode (or conducting area) 11, and a contact plate 12 connected to the conducting area with one of the procedures described hereunder. Also visible is an area 15, normally utilized for connection with conducting elements, for example a copper braid.

It is evident that the connection between electrodes and contact plates must be produced in a particularly reliable manner, and which must not impair the original properties of the materials of which they are composed.

Consolidated constructional tradition provides for electrodes and contact plates which are connected, for example, by resistance or induction braze welding; nonetheless, solutions based on alternative technologies, such as laser braze welding, as proposed in WO03056589, are also known.

This last solution in particular has made it possible to obtain general results of high production efficiency and product quality, thanks to the noteworthy possibilities of controlling the process parameters (quantity, quality and trajectory of the laser beam).

The greatest disadvantage of electrical contacts obtained with braze welding processes is the negative influence on the general cost of the switches or contactors in which they are utilized. In fact, their manufacture requires at least three different operations: a) forming of the electrode, b) forming of the contact plate and c) the braze welding process.

Moreover, as the braze welding process (resistance, induction or laser, with or without a brazing filler alloy) between electrodes and plates of the conventional type must take place in an area characterized by discontinuous chemical-physical properties, it is unavoidably the result of a series of compromises aimed at maintaining to the greatest possible extent the original properties of the two different materials. This makes the choice of the physical process parameters very restricted, and therefore critical.

In any case, the connection area between the electrode and the contact plates produced in this way is characterized by a very fast gradient of chemical physical properties and consequently it is possible that small variations in the process parameters can have a considerable influence on the quality result.

In conclusion, braze welding (whether resistance, induction or laser, with or without a brazing filler alloy) between the electrode and the contact plates is a critical process and the quality of the contacts produced may depend upon it; in particular, slight variations in the process parameters can cause deterioration of the electrical properties (i.e. an increase in electrical resistance caused by superheating of the impurities in copper) or of the mechanical properties (i.e. development of fragility in the connection).

If braze welding is carried out using a brazing filler alloy, it is also necessary to take into account the development of further problems and limits related to the presence of this further element, which having typically low melting points can pose limits to the thermal behavior of the contact.

A further known limit of braze welding with the use of a brazing filler alloy is the need to obtain contact surfaces that are perfectly clean and devoid of oxidations, which in fact would result in the rapid electrical and mechanical deterioration of the welded areas.

It is evident from the above that in the state of the art there exists the need for an efficient method to produce contacts, and in particular for that method to make it possible to obtain contacts characterized by high electrical and mechanical properties at low costs and with high reliability.

The object of the present invention is to produce an electrical contact and a method for the manufacture of electrical contacts which overcomes the drawbacks mentioned hereinbefore.

Within this object, one of the tasks of this invention is to produce an electrical contact, and a method for the manufacture thereof, wherein there are no increases in the electrical resistance caused by superheating any impurities in the copper electrode.

Yet another task of this invention is to produce a method of manufacturing electrical contacts, and an electrical contact obtained with said method, without the need for subsequent connections or welds.

Yet another task of this invention is to produce a method of manufacturing electrical contacts, and an electrical contact obtained with said method, which can be utilized in an automated production cycle.

A further task of this invention is to produce a method of manufacturing electrical contacts, and an electrical contact obtained with said method, which guarantees large scale repeatability.

Yet a further task of this invention is to produce a method of manufacturing electrical contacts, and an electrical contact obtained with said method, which is easily industrializable, at limited and economically competitive costs.

This task and these objects, together with other objects which will be apparent from the description hereunder and from the accompanying drawings, are obtained, according to the invention, with an electrical contact device which is characterized in that it comprises a contact element produced in one piece. Said contact element comprises a first conducting area and a second contact area, said first area and said second area being produced with materials of different types.

In a further aspect, the present invention relates to a process for preparing an electrical contact device which is characterized in that it comprises the following steps:
preparing a mold to produce a contact element of said device;
introducing a metered quantity of a first and a second powder into said mold respectively in a first area and in a second area of said mold;
closing said mold and applying a temperature and a pressure suitable to carry out sintering of said first and second powder;
opening the mold and removing the contact element thus produced.

The device of the present invention and the process for the preparation thereof, due to the fact that they are based on a contact element produced in one piece, but having areas with different mechanical and electrical properties, make it possible to considerably improve both the performances and the production of electrical equipment such as switches and contactors in which they are fitted.

Further characteristics and advantages of the device according to the present invention, and of the process for the preparation thereof, can be better understood by referring to the description provided hereunder and to the accompanying drawings which are provided purely for a non-limiting illustrative purpose, wherein:

FIG. 1 represents a contact element of known type;

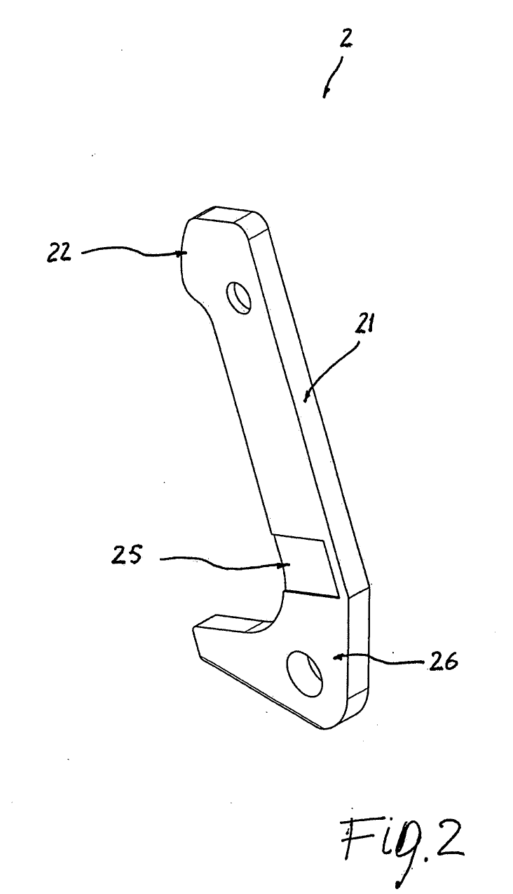

FIG. 2 represents a first embodiment of a contact element of a device according to the invention;

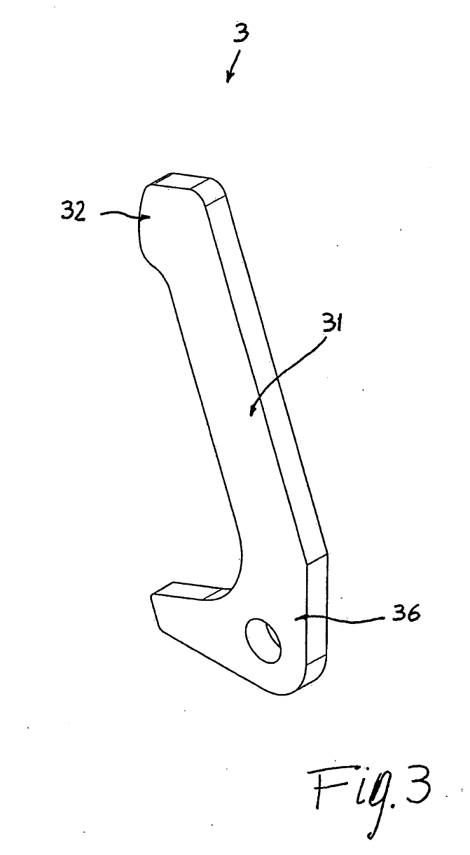

FIG. 3 represents a second embodiment of a contact element of a device according to the invention;

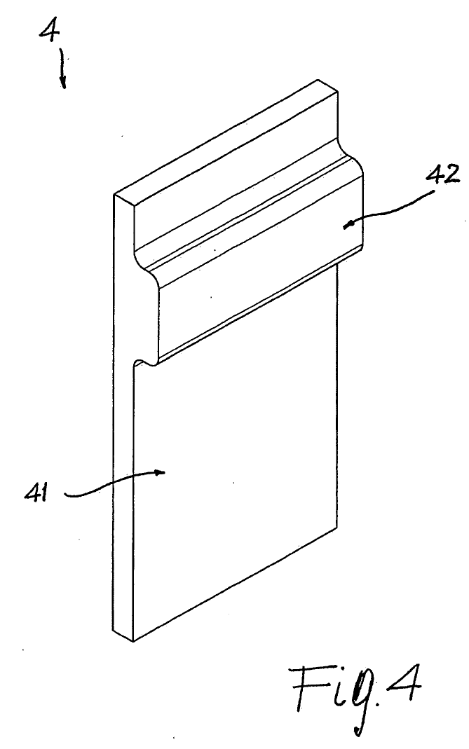

FIG. 4 represents a third embodiment of a contact element of a device according to the invention;

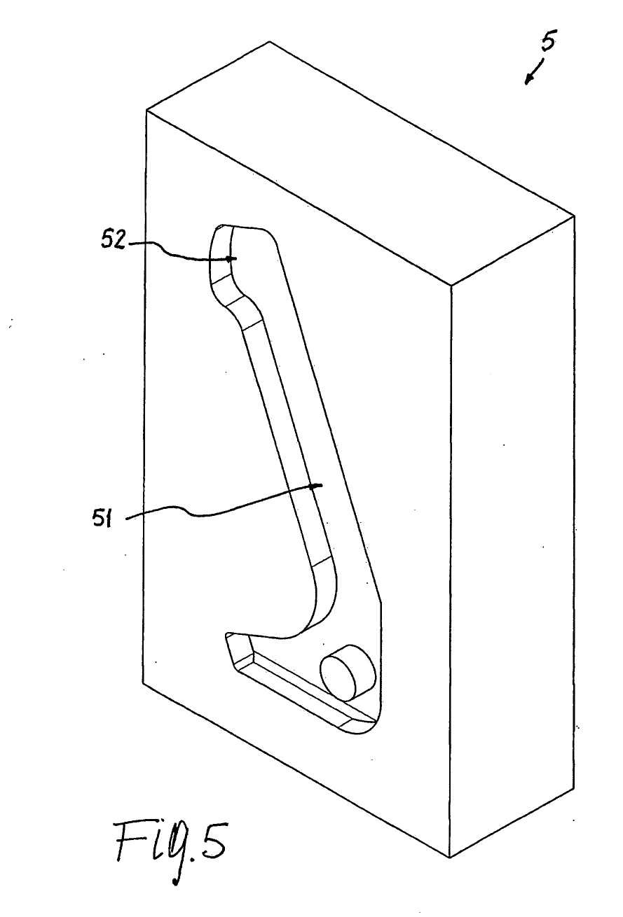

FIG. 5 represents a first embodiment of a mold utilized in the process according to the invention;

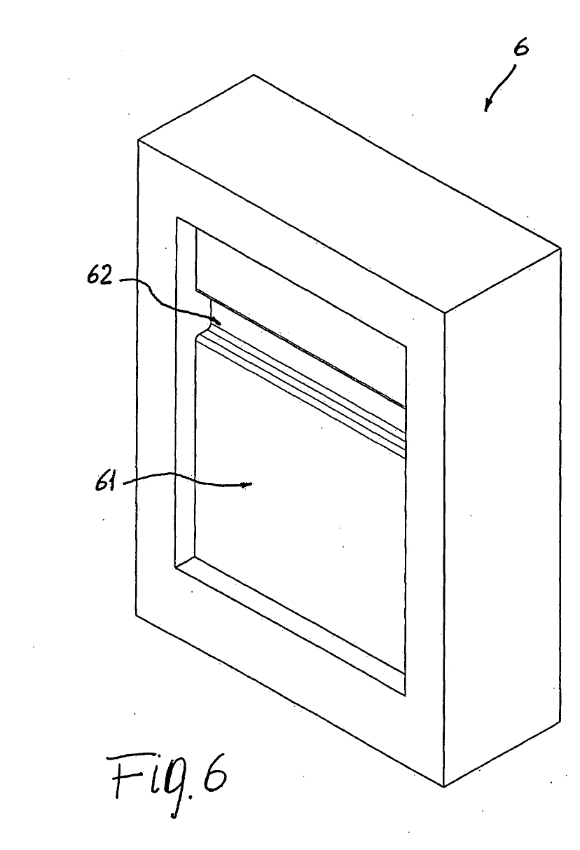

FIG. 6 represents a second embodiment of a mold utilized in the process according to the invention;

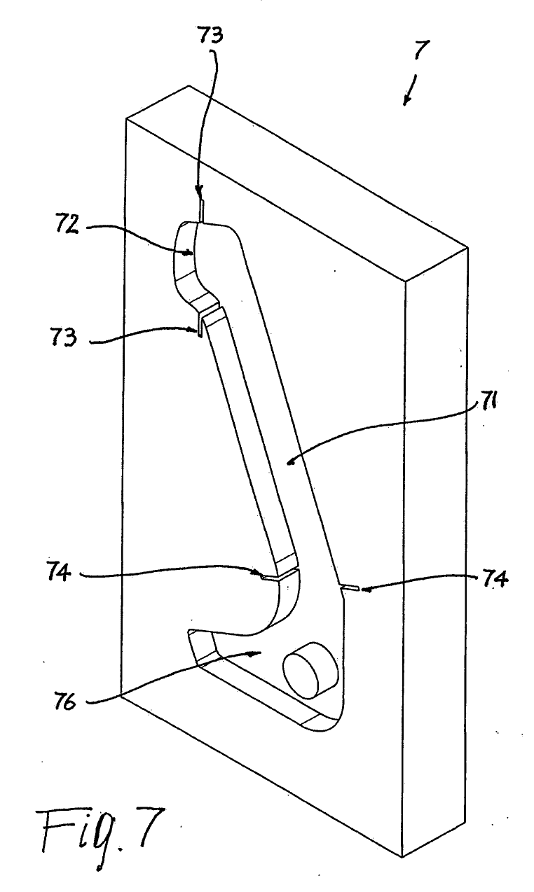

FIG. 7 represents a third embodiment of a mold utilized in the process according to the invention.

With reference to the accompanying figures, and in particular to FIGS. 2-5, the electrical contact device, according to the invention, comprises a contact element 2, 3 and 4 produced in one piece; in particular, the contact elements 2 and 3 are examples of embodiments of mobile contacts of a low-voltage switch, while the contact element 4 is an example of an embodiment of a fixed contact of a low-voltage switch.

Said contact element 2, 3 and 4 comprises a first conducting area 21, 31 and 41 and a second contact area 22, 32 and 42 and, in the device according to the invention said first area and said second area are produced with materials of different types.

Preferably, the first conducting area 21, 31 and 41 is substantially made of copper and the second contact area 22, 32 and 42 is made of compositions with a high silver content.

Nonetheless, in a more general embodiment, the first conducting area 21, 31 and 41 comprises copper and, the material of which said second area 22, 32 and 42 is made comprises silver. According to a particular embodiment, the material of which said second area 22, 32 and 42 is made comprises silver and tungsten carbide (WC) or silver and graphite.

With particular reference to FIG. 2, the contact element 2 can also comprise an area 25 suitable to promote connection with a conducting element connected to said contact element 2. This connection can be implemented through a braze welding process of conventional type or it can be implemented during production of the contact element 2 according to a method to be described hereunder.

Optionally, with reference to FIGS. 2 and 3, the contact element 2, 3 can comprise a third area (or further areas) produced with materials of different types. For example, it is possible to have a contact element 2, 3 in which a third area 26, 36 with specific properties of mechanical resistance is present; in this case the material can for example be copper and alumina (Al₂O₃) or copper alloy powder, such as copper and beryllium (Cu—Br), copper and chromium (Cu—Cr) or the like.

The contact element 2, 3, 4 of the device according to the invention is suitably produced in one piece through a sintering process of at least two powders of materials of different types, in order to define in said contact element 2, 3, 4 a first conducting area 21, 31, 41 produced with a first of said powders and a second contact area 22, 32, 42 produced with a second of said powders.

Preferably, said first powder is substantially a copper based powder and said second powder is substantially a silver based powder. Nonetheless, in a more general embodiment, the first powder is a mixture comprising a copper based powder and the second powder is a mixture comprising a silver based powder or a mixture of silver and tungsten carbide (WC), silver and nickel (Ag—Ni), silver and graphite (Ag—C), or silver and tungsten (Ag—W) powders.

With reference to the accompanying figures, the process according to the invention for preparing an electrical contact device comprises the following steps:
preparing a mold 5, 6, 7 to produce a contact element 2, 3, 4 of said device;
introducing a metered quantity of a first and a second powder into said mold 5, 6, 7, respectively in a first area 51, 61, 71 and in a second area 52, 62, 72 of said mold 5, 6, 7;
closing said mold 5, 6, 7 and applying a temperature and a pressure suitable to carry out sintering of said first and second powder;
opening the mold and removing the contact element 2, 3, 4 thus produced

The mold 5, 6, 7, can be composed of more than one die and of more than one punch

As stated hereinbefore, preferably said first powder comprises a copper based powder, and said second powder comprises a silver based powder. According to a particular embodiment, said second powder comprises a mixture of silver and, tungsten carbide (WC), silver and nickel (Ag—Ni), silver and graphite (Ag—C), or silver and tungsten (Ag—W) powders.

With reference to FIGS. 2, 3 and 7, in the case in which a contact element comprising a third (or further) area 26, 36 made of materials of different types is to be produced, the process according to the present invention provides for introducing into said mold 7 a metered quantity of a third powder, based, for example, on copper and aluminum or aluminum oxide, in a third area 76 of said mold 7.

Preferably, in the process according to the invention, the mold 5, 6, 7 is preheated prior to introduction of said powders. According to a particularly preferred embodiment, the preheating temperature is of the same order as the temperature to carry out said sintering.

Preferred sintering parameters are, for example, T=350÷700° C.; p=30÷300 kg/mm²; t=10÷100 s.

Preferably, a heat treatment at a temperature higher than the sintering temperature is carried out subsequent to removal of the sintered part, for the purpose of further improving the electrical and mechanical properties.

With reference to FIG. 7, in order to improve the properties of the conducting element and to obtain conducting and contact areas with specific compositions and electrical properties, the mold 7 is preferably predisposed for the introduction of separators between said first area 71 and said second area 72.

For this purpose, suitable grooves 73 can be provided in the mold 7 to introduce said separators (not represented in the figure). In the case in which the mold 7 is to be divided into three or more areas, it is possible to provide further grooves 74 in said mold 7 for introduction of further separators. Advantageously, said separators are positioned in the mold 7 prior to introduction of said powders, and removed prior to carrying out said sintering.

In the case in which the device according to the invention comprises a conducting element, such as a copper braid, utilized to carry the current to the contact element, said conducting element is positioned in the mold 5, 6, 7 prior to carrying out said sintering. Normally, the conducting element is positioned in the mold 5, 6, 7 substantially at the level of said first area 51, 61, 71. In this way, once the contact element 2, 3, 4 is removed from the mold, it will already be connected to said conducting element without the need for further braze welding processes or the like.

The process according to the invention can also be used to produce electrical contacts where transition from one area to the other takes place according to a suitably calculated transition of the powder mixture. Extension of the transition area is calculated, for example, on the basis of the reciprocal compatibility of the powders and of the consequent final electrical and physical effects. It can be seen in practice that the transition area between mixtures based on copper and silver respectively is preferably in the order of 0.5 mm.

The volume utilized of the different powder mixtures represents one of the sintering parameters; the initial volume must in fact take due account of the behavior of the specific powder composition during sintering. It was seen, for example, that copper powders are subject to a greater reduction in volume in respect, for example, to silver powders. The initial volume utilized, if suitably calculated with appropriate increases in powder quantity, ultimately permits the exact final state desired to be obtained in all the characteristic areas.

It was seen in practice that the device according to the invention, and the method for the preparation thereof, solve the problems of prior art and offer numerous advantages with respect thereto, as welding/brazing techniques and the problems related thereto are avoided The combination of characteristics of the method according to the invention in particular makes it possible to avoid problems typical of processes based on prior art braze welding technologies.

With the method according to the invention it is thus possible to obtain electrical contacts, both fixed and mobile, which have improved characteristics with respect to prior art. In particular, it is possible to obtain electrical contacts in which the area to act as electrode is composed substantially of copper, and the area for opening and closing of the arc has the normal characteristics of plates based on sintered silver powders, but is formed together with the electrode and not subsequently connected thereto.

The switches or contactors including said contacts form a further aspect of the present invention.

It has been seen how the method according to the invention and the electrical contacts obtained therefrom fully accomplish the specified object and tasks. On the basis of the description provided, other characteristics, modifications or improvements are possible and evident to the average person skilled in the art. These characteristics, modifications and improvements are therefore to be considered part of the present invention.

In practice, the materials used, the dimensions and contingent forms can be any according to requirements and to the state of the art.

1. Electrical contact device, characterized in that it comprises a contact element (2, 3, 4) produced in one piece, said contact element (2, 3, 4) comprising a first conducting area (21, 31, 41) and a second contact area (22, 32, 42), said first area and said second area being produced with materials of different types.

2. Electrical contact device as claimed in claim 1, characterized in that said first conducting area (21, 31, 41) is substantially made of copper and said second contact area (22, 32, 42) is substantially made of silver.

3. Electrical contact device as claimed in claim 1, characterized in that the material with which said first conducting area (21, 31, 41) is produced comprises copper, and the material with which said second area (22, 32, 42) is produced comprises silver.

4. Electrical contact device as claimed in claim 1, characterized in that the material with which said second area (22, 32, 42) is produced comprises silver and tungsten carbide (WC), silver and nickel (Ag—Ni), silver and graphite (Ag—C), or silver and tungsten (Ag—W).

5. Electrical contact device as claimed in claim 1, characterized in that it comprises a conducting element connected to said contact element (2, 3, 4).

6. Electrical contact device, characterized in that it comprises a contact element (2, 3, 4) produced in one piece through a sintering process of at least two powders of conductive materials of different types in order to define in said contact element (2, 3, 4) a first conducting area (21, 31, 41) produced with a first of said powders and a second contact area (22, 32, 42) produced with a second of said powders.

7. Electrical contact device as claimed in claim 6, characterized in that said first powder is substantially a copper based powder and said second powder is substantially a silver based powder.

8. Electrical contact device as claimed in claim 6, characterized in that said first powder is a mixture comprising a copper based powder and the second powder is a mixture comprising a silver based powder.

9. Electrical contact device as claimed in claim 6, characterized in that said first powder comprises copper, and said second powder comprises a mixture of silver and tungsten carbide (WC) powders.

10. Electrical contact device as claimed in claim 6, characterized in that it comprises a conducting element connected to the first conducting area (21, 31, 41) of said contact element (2, 3, 4), connection between said conducting element and said contact element (2, 3, 4) being produced during said sintering process.

11. Process for preparing an electrical contact device characterized in that it comprises the following steps:
preparing a mold (5, 6, 7) to produce a contact element (2, 3, 4) of said device;
introducing a metered quantity of a first and a second powder into said mold (5, 6, 7), respectively in a first area (51, 61, 71) and in a second area (52, 62, 72) of said mold (5, 6, 7);
closing said mold (5, 6, 7) and applying a temperature and a pressure suitable to carry out sintering of said first and second powder;
opening the mold and removing the contact element (2, 3, 4) thus produced.

12. Process as claimed in claim 11, characterized in that said first powder comprises a copper based powder and said second powder comprises a silver based powder.

13. Process as claimed in claim 11, characterized in that said second powder comprises a mixture of silver and tungsten based powders.

14. Process as claimed in claim 11, characterized in that said mold (5, 6, 7) is preheated prior to introduction of said powders.

15. Process as claimed in claim 14, characterized in that the preheating temperature is substantially the same as the temperature to carry out said sintering.

16. Process as claimed in claim 11, characterized in that said mold (5, 6, 7) is predisposed for the introduction of separators between said first area (51, 61, 71) and said second area (52, 62, 72).

17. Process as claimed in claim 16, characterized in that said separators are positioned prior to introduction of said powders and removed prior to carrying out said sintering.

18. Process as claimed in claim 11, characterized in that a conducting element of said electrical contact device is positioned in the mold (5, 6, 7) substantially at the level of said first area (51, 61, 71) prior to carrying out said sintering.

19. Contact device produced with a process as claimed in claim 11.

20. Switch, particularly a low-voltage switch, comprising a contact device as claimed in claim 1.

21. Contactor, particularly a low-voltage contactor, comprising a contact device as claimed in claim 1.
